(19) United States
(12) Patent Application Publication
(10) Pub. No.: US 2025/0050287 A1
(43) Pub. Date: Feb. 13, 2025

(54) METHOD FOR REGULATING THE MOISTURE IN A GAS

(71) Applicant: H2GREMM, EDERN (FR)

(72) Inventors: Ilies DRISS, Les Champs Géraux (FR); Stéphan LATIL, Chateaulin (FR); Alain ROCHEUX, Quimper (FR)

(21) Appl. No.: 18/719,868

(22) PCT Filed: Dec. 16, 2022
(86) PCT No.: PCT/EP2022/086275

§ 371 Date: Jun. 14, 2024

(30) Foreign Application Priority Data
Dec. 24, 2021 (FR) FR2114510

(51) Int. Cl. B01F 23/231; B01D 53/26; B01F 35/221; B01F 35/92; B01F 101/55; C25B 15/08

(52) U.S. Cl. CPC B01F 23/231233; B01D 53/261; B01F 35/2215; B01F 35/92; C25B 15/08; B01D 2257/80; B01D 2259/40084; B01F 2101/55; B01F 2215/044; B01F 2215/045

(57) ABSTRACT

A method for regulating the humidity in a gas. In the first step, the humidity in a gas entering a bubbler at a flow rate is regulated between 200 NL/h and 2,000 NL/h. The gas entering the bubbler through the inlet of the bubbler tank passes throughout the first porous matrix. The humidified gas comes out through the outlet of the bubbler tank and circulates towards a compressor. In the second step, the gas derived from the first step is dried. The gas coming out of the compressor passes through a T-shaped tube including one inlet and two outlets. One of the outlets is arranged vertically and lets the liquid phase of the gas flow by gravity effect, thereby creating a condensate. The other outlet is connected at the bottom of a desiccant reservoir.

### TECHNICAL FIELD OF THE INVENTION

The present invention relates to a method for regulating the humidity of a gas. In particular, it applies to the method requiring hydrogen moisture-saturated at the inlet and dry at the outlet.

For example, the field of the invention applies to electrochemical compressors or to gas separators.

### PRIOR ART

In existing systems or existing methods, the gas at the inlet should contain enough relative humidity for the system to operate properly. The gas at the outlet must contain an absolute humidity low enough in order to be stored and used in various applications.

There are documents disclosing methods for humidifying a gas by means of a bubbler, for example the documents US2010/201006, CN112713288, US2003/188638 and FR2018902.

The relative humidity corresponds to the ratio of the partial pressure of the water vapor contained in the air to the saturation vapor pressure (or saturated vapor) at the same temperature.

If the gas at the inlet does not contain enough humidity, the system could be damaged or destroyed on the short run.

If the gas at the outlet contains too much humidity, the storage elements as well as the pressure regulators might corrode and the elements using this excessively humid hydrogen might have their service life reduced. To avoid these problems, the standards require a humidity concentration in hydrogen lower than 5 ppm.

The system operates at a given optimum temperature (for example from 20° C. to 60° C.).

In order to reach humidity saturation of the gas at the inlet of the system, the humidity regulation method should operate at the same inlet temperatures and pressure as the system.

At the outlet of the system, the dryer should operate at the setpoint pressure of the system (for example between 300 and 1,000 bar).

The system operates for gas flow rates comprised between 200 and 2,000 NL/hour.

The NL/hour unit means normal liter per hour or liter of gas per hour at standard temperature and pressure conditions. The flow rate may be measured with a flowmeter and be controlled by means of this flowmeter.

For convenience, we will call “bubbler” the method for regulating the humidity of the gas at the inlet and “dryer” the method for regulating the humidity at the outlet.

A bubbler consists of a tank containing liquid water throughout which a gas passes in the form of microbubbles. The gas in contact with the water is humidified until reaching saturation depending on the temperature and pressure conditions in the bubbler.

A temperature maintenance system is installed between the bubbler and the compressor to avoid having cold spots and always remain at a temperature higher than the condensation temperature of the gas.

Solutions exist but it is not possible to meet the need with a bubbler sold on the market because it does not allow withstanding pressures higher than a few bars.

The use of a dew point controller would allow achieving an accurate control of the moisture content. However, this solution is much more expensive and complex and does not accept pressures higher than a few bars.

To overcome this problem, the manufacturers do not wish to invest in a dew point controller and wish to use a piece of equipment that is less expensive and more robust, maintain the temperature of their bubbler using an electrical resistance: electrical heating cables are arranged along the gas pipes in order to avoid the cold spots between the bubbler and the system. The objective is to maintain a sufficient temperature without having condensation.

Gas drying solutions allowing reaching 5 ppm for flow rates of 200 to 2,000 NL/h are numerous:
The desiccation dryer enables operation up to 1,000 bar and has a very good drying capacity, the drawback is that it requires replacement or regeneration of the desiccant when it is saturated with water. Customized enclosures withstanding average pressures (up to 700 bar) are nowadays used, they allow containing the desiccant as well as the condensed water. The compressed gas and the condensate are in the same enclosure. During condensate purges, a portion of the gas is lost, as it is discharged at the same time as the water. They consist of massive and expensive parts made of stainless steel. Each maintenance requires replacement of the gasket ensuring sealing. In general, the design of these enclosures makes this procedure delicate.
The solution consisting in drying by permeation has the same regeneration problem and uses for this purpose a portion of the dried hydrogen to absorb the moisture accumulated on the membranes, there are therefore significant gas losses. Another drawback is the operating pressure which does not accept pressures higher than 35 bar for small installations and therefore at a low flow rate.
The solution consisting in drying using a cold generation unit available on the market allows reaching a dew temperature close to 0° C. but does not accept a pressure higher than a few bars. Hence, it is not possible to reach 5 ppm under these pressure and temperature conditions.
The solution consisting in phase separation by coalescence allows separating the liquid and vapor water phases. This solution does not allow achieving a sufficient drying.

### DISCLOSURE OF THE INVENTION

The present invention aims to overcome these drawbacks with a completely novel approach.

More specifically, the invention aims to:
Guarantee that the inflow gas is saturated with moisture, i.e. 70%≥HR 99%;
Guarantee that the outflow gas has a water concentration lower than 5 ppm.

Another objective is to guarantee the saturation of the gas with humidity irrespective of the operating temperature.

In particular, an objective of the invention is to provide such a technique allowing getting rid of any other complex setting system.

Another objective of the invention is to provide such a technique which is inexpensive to implement and which does not require a particular maintenance.

These objectives, as well as others that will appear later on, are achieved, according to a first aspect, using a method for regulating the humidity of a gas, remarkable in that it includes the following steps:
a first step of regulating the humidity of a gas entering a bubbler at a flow rate comprised between 200 NL/h and 2,000 NL/h and the relative humidity of the gas entering the compressor is comprised between 70% and 99%, said bubbler comprises the following elements:
   a bubbler tank including an inlet and an outlet,
   a thermoregulation tank which surrounds said bubbler tank,
   a volume of thermoregulation water contained in said thermoregulation tank,
   a pump for circulating thermoregulation water;
   said bubbler tank includes a first porous matrix located at the bottom of the bubbler tank proximate to the inlet;
      the gas entering the bubbler through the inlet of the bubbler tank passes throughout the first porous matrix positioned in a volume of water contained in the bubbler tank, the humidified gas comes out through the outlet of the bubbler tank and circulates towards a compressor; the volume of thermoregulation water circulates in a closed circuit passing through the thermoregulation tank, the circulation pump and the compressor;
a second step of drying the gas derived from the first step, the gas coming out of the compressor passes through a T-shaped tube including an inlet and two outlets, one of the outlets is arranged vertically and lets the liquid phase of the gas flow by gravity effect thereby creating a condensate, the other outlet is connected at the bottom of a desiccant tank; at the outlet of the desiccant tank, the dried gas is stored towards a tank and includes a humidity lower than a predetermined threshold.

Thanks to these provisions, the gas entering the compressor is saturated with moisture, i.e. 70%≥HR≥99% and optimizes its operation; and after the step of the dryer, the outflow gas carries a water concentration lower than 5 ppm which allows having various applications.

There are other advantages like the need for less cooling in comparison with another method, a method wherein the conditions of the outflow gas are ensured and complied with.

Moreover, the inner volume of the bubbler is used as a damper of the variations in the pressure of the inflow gas, thereby allowing for the simplified management of the compressor.

The bubbler maintains an optimum water level using an automated purging and filling system.

A unique temperature regulator installed around the bubbler allows tuning the temperatures of the bubbler and of the associated compressor.

By separating the condensate upstream of the gas dryer, the gas losses are minimized during the purges of this condensate.

The design of a dryer based on standard components enables a reduction in costs, a simplification of maintenance and a greater modularity.

Advantageously, the invention is implemented according to the embodiments and the variants disclosed hereinafter, which should be considered individually or according to any technically-feasible combination.

In one embodiment, during the first step, the inflow gas is derived from an electrolyzer and includes a relative humidity lower than 50%.

In one embodiment, during the first step, the temperature of the thermoregulation water is ensured by a thermoregulation element.

In one embodiment, the thermoregulation element of the first step includes fins placed around the thermoregulation tank.

In one embodiment, the thermoregulation element of the first step includes a fan configured to ensure the circulation of air in contact with the fins.

In one embodiment, during the first step, a second porous matrix is located at the top portion of the bubbler tank proximate to the outlet of the tank of the bubbler, the humidified gas passes through the second porous matrix before coming out of the bubbler tank. It is used as a safety element preventing the passage of liquid water.

In one embodiment, during the first step, the relative humidity of the gas entering the compressor is comprised between 70% and 99%, preferably between 95% and 99%.

In one embodiment, said method includes a third stopping step for purging the volume of water contained in the bubbler tank and then filling it with a new volume of water.

In one embodiment, during the third stoppage step, the condensate contained in one of the outlets of the T-shaped tube is purged.

In one embodiment, when the moisture content of the gas is higher than the predetermined threshold, preferably when it exceeds the threshold of 5 ppm, said method includes a step of warning visually, audibly or by a terminal indicating the need for replacement of the desiccant.

### BRIEF DESCRIPTION OF THE FIGURES

Other advantages, aims and features of the present invention appear from the following description, made for an explanatory and non-limiting purpose, with reference to the appended drawings, wherein:

FIG. 1 shows a block diagram of the invention object of the present invention;

FIG. 2 shows the steps of the regulation method object of the present invention.

### DESCRIPTION OF THE EMBODIMENTS

### Inflow Gas:

In order to achieve a relative humidity of the inflow gas comprised between 70 and 100% at the inlet, the bubbler is maintained at a temperature close to the temperature of the inflow gas.

An identical temperature allows reaching 100% relative humidity.

Hence, the bubbler should be maintained at a temperature lower than a few degrees with respect to the temperature of the inflow gas in order to keep the relative humidity level within the required range (70%≥HR≥99%).

If the temperature of the bubbler is higher than the temperature of the inflow gas, condensation appears, which could adversely affect the overall operation.

To do so, the inflow gas is temperature-regulated by means of a thermoregulator. The thermoregulation is performed at the level of the bubbler using a finned tube and a fan.

The solution consists in encapsulating the bubbler and inflow gas set into the same thermoregulated circuit. This allows avoiding electrical consumption for maintaining the temperature (resistances and heating cables). The bubbler and the coaxial tube containing the inflow gas contribute to heat dissipation in the event where the system produces an exothermic reaction requiring cooling.

Consequently, sizing of the thermoregulator is slightly smaller than the initial configuration necessary for the same amount of inflow gas.

### Outflow Gas:

The object of the invention for the drying portion replicates the feature of drying by desiccation, but modifies its architecture. This new architecture allows collecting the liquid phase before passage through the desiccant. The separation of these two phases allows simplifying mounting as well as substantially limiting gas losses at each purge.

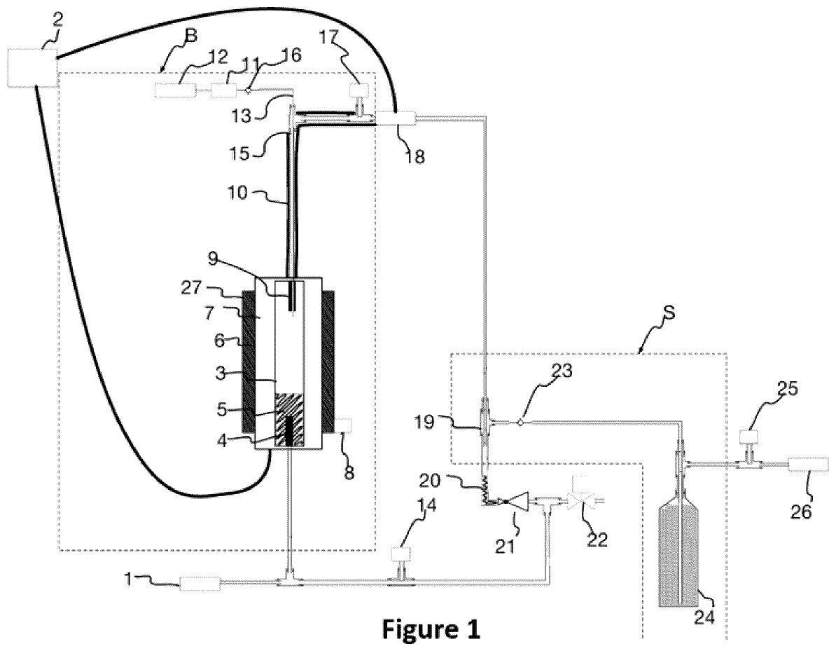

FIG. 1 shows a block diagram of the invention.

The bubbler B consists of an enclosure containing a volume of water 5 sized according to the needs of the amount of gas to be treated, accepting pressures of a few ten bars, made of a material that is a good heat conductor and corrosion-resistant. The inflow gas is derived from an electrolyzer 1. In the example, the inflow gas is hydrogen. The flow rate comprised between 200 and 2,000 NL/h, not having enough relative humidity (<50%) under the pressure and temperature conditions prevailing in the system. For example, 35° C. at 35 bar. The flow rate is bound by the operating power of the electrolyzer.

A bubbler tank 3 made of stainless steel combines all these features. The microbubbles are created by inserting a first porous matrix 4 therein. A porous matrix is a solid material containing small-sized pores or cavities which leave room for a fluid to flow. This material may consist of different materials: metal, ceramic, carbon, plastic, etc.

The bubbler tank 3 includes an inlet and an outlet.

The cylinder-shaped bubbler tank 3 is inserted into the thermoregulation tank 6 in which the thermoregulation water 7 circulates. The thermoregulation water 7 is in a closed circuit, it can in no case be located in the bubbler tank 3.

This thermoregulation water 7 also circulates in a tube 9 coaxial with the tube transporting hydrogen between the bubbler and the compressor 18.

According to another variant, the compressor 18 is an apparatus requiring a moisture-saturated gas.

During operation, the moisture-unsaturated gas, originating from the electrolyzer enters the bubbler tank 3 and passes throughout the first porous matrix 4 itself placed in the volume of water 5. The first porous matrix 4 is located at the bottom of the bubbler tank 3 proximate to the inlet of the thermoregulation tank 6.

The humidified gas passes through a second porous matrix 9 which allows avoiding any rise of liquid water and letting only the gaseous phase pass.

A measurement of the humidity is performed using a dew point sensor 17, this sensor allows ensuring that the moisture content is actually comprised between 70% and 99%.

After stoppage, a purge of the remaining volume of water 5 is done by means of a first solenoid valve 22, followed by an automatic filling using a second solenoid valve 11; the water originating from a filtering system 12. This allows restoring a sufficient amount of water for the duration of an operating session. The water is injected directly into the bubbler using a tube 13 coaxial with the tube 15 enabling the circulation of the gas. A check valve 16 protects the filtering system 12 from the pressure of the gas during the restart of the system. During filling, the pressure sensor 14 enables management of the injected amount of water. Indeed, the addition of water into the bubbler reduces the volume available for the gas, resulting in an increase in the pressure of the latter.

Fins 27 are placed around the thermoregulation tank, they allow maximizing heat exchange with the outside air. Where necessary, a fan 8 allows for a better circulation of air in contact with the fins and an accurate control of the cooling temperature. An alternative solution consists in replacing this integrated thermoregulation system with the bubbler by an independent system.

According to one embodiment, the temperature of the thermoregulation tank is close to the temperature of the compressor with a difference comprised between −1° C. and −10° C.

According to another embodiment, the temperature of the thermoregulation tank is identical to the temperature of the compressor.

After passing through the compressor 18, the gas is dried in two steps.

The first step consists in separating the liquid phase from the gas phase. A T-shaped tube 19 crossed by a thin tube placed vertically, will enable a separation of the two phases by gravity. The speed of the fluid is low enough (about 1 cm/sec) so that the water flows and is not entrained by the gas during rise thereof towards the T-shaped tube 19. The liquid water 20 is stored in a tube throughout the operating session. This water is discharged at the same time as the water of the bubbler at the end of the session using the first solenoid valve 22. Before this, an expansion is performed by means of a pressure regulator 21. This expansion allows equalizing the output pressures of the dryer and of the bubbler and avoids a purge at more than 300 bar, which would create a safety risk for the user, as well as alterations on the equipment operating at low pressure 1 and 3.

One of the advantages of separating the condensate 20 (liquid water) of the desiccant tank 24 by means of a check valve 23 is that it is no longer necessary to purge the entire tank at the end of each cycle. Only the condensate portion is purged. The achieved gain is significant. For example, with a desiccant tank of 1 L, and an operating pressure of 400 bar, this represents 400 NL of gas losses avoided namely about one hour of operation at each cycle in comparison with a solution mixing condensate and desiccant.

Once separated from the liquid phase, the hydrogen gas is conveyed into the bottom of a desiccant tank 24. During rise thereof towards the outlet at the neck of the desiccant tank 24, humidity in the form of vapor contained in the gas is absorbed by the desiccant beads. The efficiency of this absorption is ensured until total saturation of the capacity of the desiccant. Once saturated, the desiccant is replaced or regenerated. The volume of the tank conditions the amount of desiccant and therefore the periodicity of maintenance. For example, in order to meet the need for treatment of a gas whose flow rate is 5,000 NL/day, a desiccant tank with 1 L capacity is enough to space the maintenance periods by one year.

The dry gas is stored in a pressurized tank 26. This gas is subsequently consumed throughout various applications. According to another variant, the tank 26 is an apparatus or a capacity requiring a gas with a very low moisture content. The dew point sensor 25 allows controlling the residual moisture content in the outflow gas stream. Depending on the objective, for example 5 ppm, exceeding this value will trigger an alert for replacing the desiccant.

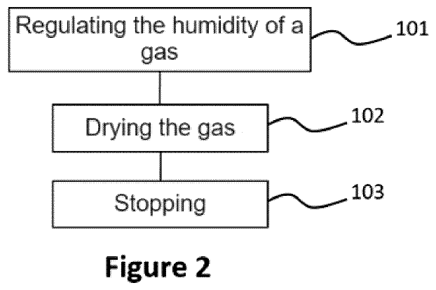

FIG. 2 shows the steps of the method for regulating the relative humidity of a gas, object of the present invention.

A first step 101 of regulating the humidity of a gas entering a bubbler B, said bubbler B is contained in a thermoregulation tank 6 in which a thermoregulation water 7 circulates in a closed circuit. The humidified gas comes out of the bubbler B before arriving at a compressor 18. The water circulation pump 2 is used to circulate around the bubbler B water that has a given temperature and which avoids heat-up of the whole.

A second step 102 of drying the gas derived from the first step, said drying separates the liquid phase from the gas of the gas phase by a T-shaped tube including an inlet and two outlets, one of the outlets is arranged vertically and lets the liquid phase of the gas flow by gravity effect, the other outlet is connected at the bottom of a desiccant tank 24; at the outlet of the desiccant tank, the dried gas is stored towards a tank 26.

A third step 103 of stopping to purge the volume of water 5 of the bubbler and the condensate of the dryer 20 then filling with a new volume of water 5.

TABLE 1
LIST OF THE REFERENCE SIGNS

| References | Designations |
|---|---|
| 1 | Electrolyzer |
| 2 | Circulator pump |
| 3 | Bubbler tank |
| 4 | First porous matrix |
| 5 | Water |
| 6 | Thermoregulation tank |
| 7 | Thermoregulation water |
| 8 | Fan |
| 9 | Second porous matrix |
| 10 | Coaxial tube containing the thermoregulation water |
| 11 | Second solenoid valve |
| 12 | Water filter |
| 13 | Water fill tube |
| 14 | Temperature sensor |
| 15 | Hydrogen tube |
| 16 | Check valve |
| 17 | Dew point sensor |
| 18 | Compressor |
| 19 | T-shaped tube |
| 20 | Condensate |
| 21 | Pressure regulator |
| 22 | First solenoid valve |
| 23 | Check valve |
| 24 | Desiccant tank |
| 25 | Dew point sensor |
| 26 | Tank |
| 27 | Fins |
| B | Bubbler portion |
| S | Dryer portion |

1-10. (canceled)

11. A method for regulating a humidity of a gas, comprising:
a first step of regulating the humidity of the gas entering a bubbler at a flow rate between 200 NL/h and 2,000 NL/h and regulating a relative humidity of the gas entering a compressor between 70% and 99%, the bubbler comprising:
a bubbler tank comprising an inlet, an outlet, and a first porous matrix located at a bottom of the bubbler tank proximate to the inlet;
a thermoregulation tank which surrounds the bubbler tank;
a volume of thermoregulation water contained in the thermoregulation tank; and
a circulation pump to circulate the thermoregulation water;
wherein the first step further comprises:
passing the gas entering the bubbler through the inlet of the bubbler tank throughout the first porous matrix positioned in a volume of water contained in the bubbler tank;
circulating a humidified gas exiting through the outlet of the bubbler tank towards a compressor;
circulating the volume of thermoregulation water in a closed circuit passing through the thermoregulation tank, the circulation pump and the compressor; and
the second step of drying the gas derived from the first step and the second step further comprising:
passing the gas exiting the compressor through a T-shaped tube, the T-shaped tube comprising an inlet and two outlets;
arranging vertically one of the two outlets to let a liquid phase of the gas flow by gravity effect, thereby creating a condensate;
connecting other of two outlets at a bottom of a desiccant tank; and
wherein at an outlet of the desiccant tank, the dried gas is stored towards a storage tank and a humidity at the outlet of the desiccant tank is lower than a predetermined threshold.

12. The method of claim 11, wherein the first step further comprises deriving the gas entering the bubbler from an electrolyzer, a relative humidity of the gas being lower than 50%.

13. The method of claim 11, wherein the first step further comprises regulating a temperature of the thermoregulation water using a thermoregulation element.

14. The method of claim 13, wherein the thermoregulation element comprises fins placed around the thermoregulation tank.

15. The method of claim 14, further comprising circulating air in contact with the fins using a fan of the thermoregulation element.

16. The method of claim 11, wherein the first step further comprises locating a second porous matrix in an upper portion of the bubbler tank proximate to the outlet of the bubbler tank and passing the humidified gas through the second porous matrix before the humidified gas exits out of the bubbler tank.

17. The method of claim 11, wherein the relative humidity of the gas entering the compressor is between 95% and 99%.

18. The method of claim 11, further comprising a stoppage step for purging the volume of water contained in the bubbler tank and then filling the bubbler with a new volume of water.

19. The method of claim 18, wherein the stoppage step further comprises purging the condensate contained in the one of the two outlets of the T-shaped tube.

20. The method of claim 11, further comprising a step of warning visually, audibly or by a terminal indicating a need to replace a desiccant when a moisture content of the gas is higher than a predetermined threshold.

21. The method of claim 20, wherein the predetermined threshold is 5 ppm.
